(19) United States
(12) Patent Application Publication
(10) Pub. No.: US 2026/0070506 A1
(43) Pub. Date: Mar. 12, 2026

(54) School Bus Service Door Facial and Skull Protection Bumpers

(71) Applicant: John P. Crittenden, Staatsburg, NY (US)

(72) Inventor: John P. Crittenden, Staatsburg, NY (US)

(21) Appl. No.: 19/321,840

(22) Filed: Sep. 8, 2025

Related U.S. Application Data
(60) Provisional application No. 63/692,511, filed on Sep. 9, 2024.

(51) Int. Cl. B60R 21/04; B60J 5/04; B60J 5/06

(52) U.S. Cl. CPC B60R 21/0428; B60J 5/0493; B60J 5/062

(57) ABSTRACT

A protection device for a manual bus service door opening mechanism is described. The protection device comprises at least one first protection bumper configured to cover rigid edges of a rotatable pivot arm, the rigid edges facing an aisle of a bus, wherein the rotatable pivot arm connects a bus service door to the manual bus service door opening mechanism via a linkage connecting the bus service door to a handle through the rotatable pivot arm.

This application claims the benefit of U.S. Provisional Patent Application Ser. No. 63/692,511, (PC24-001(PR)), filed on Sep. 9, 2024, which is herein incorporated by reference in its entirety.

### (1) TECHNICAL FIELD

This disclosure relates to a device protecting school bus drivers and passengers, and more particularly, protection bumpers to add to cap portions of the school bus door controls to protect driver and passengers from injury from the door controls.

### (2) BACKGROUND

A manual school bus door opening mechanism may have parts similar to those shown in FIG. 1. Typically made of metal, these include a base plate and latch, for example. In the case of a collision, the metal parts present a danger to the school bus driver. The metal base plate is directly facing the aisle of the school bus. Students and roving bus monitors are vulnerable to injury from these metal parts, especially while students are entering and exiting the bus. Although the bus may be stationary, if a rear end collision were to occur, the base plate could cause serious injury to anyone near it. Also, upon exiting, if a student were to trip, bend over to grab something, or be pushed by another student, the metal base plate could cause serious injury. Roving monitors are vulnerable constantly to injury.

U.S. Pat. Nos. 4,200,167 (Cockman, Jr.) and 6,089,647 (Glanton et al) show manual school bus door operating systems. U.S. Pat. Nos. 10,549,690 (Englander et al), 6,079,768 (Kalina), and 8,182,125 (Englander et al) show various school bus safety features. www.eberhard.com/product/bus-parts/22-c-30 and www.inductrialhwe.com/images/450-457.pdf show door opening mechanism parts.

### SUMMARY

A principal objective of the present disclosure is to protect bus drivers and passengers from injury caused by impact with bus door controls.

Another objective of the present disclosure is to provide protection bumpers for installation on existing bus door controls to protect bus drivers and passengers from injury caused by impact with bus door controls.

A further objective is to provide a modified bus door control base plate made of a protective material to protect bus drivers and passengers from injury caused by impact with bus door controls.

In accordance with the objectives of the disclosure, a protection device for a manual bus service door opening mechanism is achieved. The protection device comprises at least one first protection bumper configured to cover rigid edges of a rotatable pivot arm, the rigid edges facing an aisle of a bus, wherein the rotatable pivot arm connects a bus service door to the manual bus service door opening mechanism via a linkage connecting the bus service door to a handle through the rotatable pivot arm.

Also in accordance with the objectives of the disclosure, a protection device for a manual bus service door opening mechanism is achieved comprising a firm rubber rotatable pivot arm having rounded edges wherein the firm rubber rotatable pivot arm connects a bus service door to the manual bus service door opening mechanism via a linkage connecting the bus service door to a handle through the rotatable pivot arm.

### BRIEF DESCRIPTION OF THE DRAWINGS

In the accompanying drawings forming a material part of this description, there is shown:

FIG. 1 is an orthogonal view of an example bus door control mechanism of the present disclosure.

FIG. 2 is an orthogonal view of the example bus door control mechanism of FIG. 1 having the protection bumpers in a first embodiment of the present disclosure.

FIG. 3 is an orthogonal view of an example bus door control mechanism in a second embodiment of the present disclosure.

FIGS. 4A-C are top views of example protective bumpers shown in FIG. 2 in the first embodiment of the present disclosure.

FIGS. 5A-C are bottom views of example protective bumpers shown in FIG. 2 in the first embodiment of the present disclosure.

FIGS. 6A-C are back views of example protective bumpers shown in FIG. 2 in the first embodiment of the present disclosure.

FIGS. 7A-C are side views of example protective bumpers shown in FIG. 2 in the first embodiment of the present disclosure.

### DETAILED DESCRIPTION

The present disclosure provides a means to protect bus drivers and passengers from injury due to impact with bus door opening controls.

Referring now to FIG. 1, there is shown an example of manual bus door controls that might be found in a school bus or other commuter bus. A connecting linkage 10 of some kind, such as the example shown in FIG. 1, connects the door of the bus to the controls through a rotatable pivot arm comprising base plate 12. The handle 14 is pushed by the driver to engage the rotatable pivot arm and the connecting linkage to open or close the bus door. In this example, an apparatus lock 16 is first lifted by the driver before the handle can cause the door to open.

Typically, the bus door controls are made of metal. The apparatus latch piece 16a is closest to the driver's head. If a T-bone collision should occur, the driver would be most vulnerable to injury from the latch piece 16a, and to a lesser degree, the opposite end 16b of the latch piece would also be a danger. The driver would be especially vulnerable to facial or skull injuries.

The metal base plate 12 and lock portion 16a are directly facing the aisle of the school bus. Students and roving bus monitors are vulnerable to injury from these metal parts, especially while students are entering and exiting the bus. Although the bus may be stationary, if a rear end collision were to occur, the base plate could cause serious injury to anyone near it. Also, upon exiting, if a student were to trip, bend over to grab something, or be pushed by another student, the metal base plate or apparatus lock pieces 16a and 16b could cause serious injury. Roving monitors are vulnerable constantly to injury. Injuries could be to the face, skull, or other body parts.

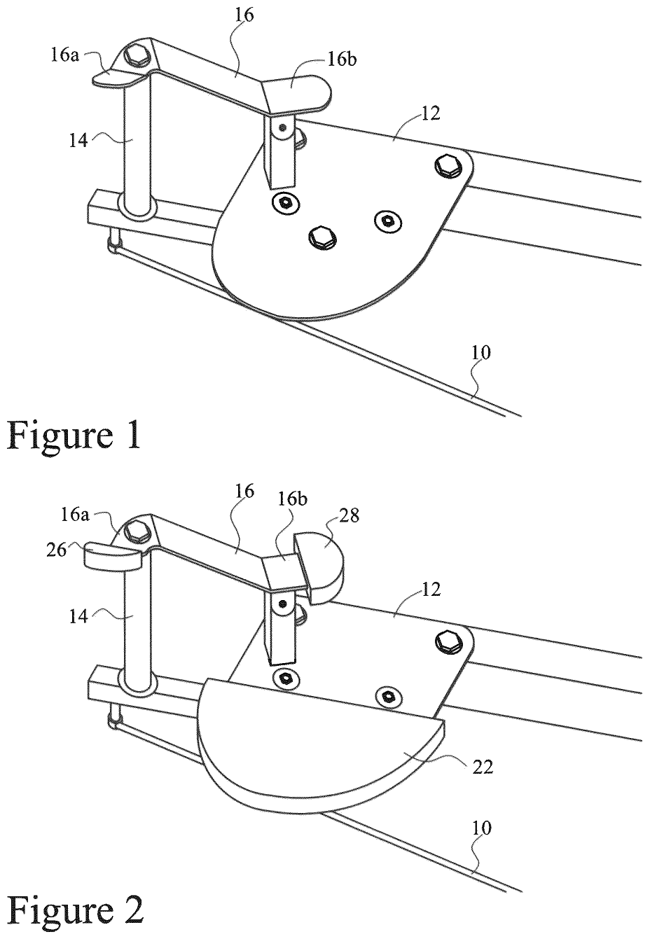

FIG. 2 illustrates the protection bumpers of the present disclosure. Protection bumpers 22, 26, and 28 are made of a firm rubber to cap the three danger spots. Preferably, the protection bumpers will have rounded edges. Protection bumper 22 covers the edges of metal plate 12 of the rotatable pivot arm. Protection bumper 26 covers the edge 16a of the latch apparatus and protection bumper 28 covers the opposite edge 16b. The protection bumpers cover enough of the metal edges so that, if there is contact between the door opening parts and a person, the metal parts would be much less likely to cause a laceration. These protection bumpers are an add-on safety measure to the existing apparatus (service door opener) from the bus factory. The protection bumpers can be designed to fit any particular shape of the metal parts and any other metal parts or parts made of any other rigid material, that make up a service door opening system and could be a danger to driver and/or passengers.

Preferably, the protection bumpers are made of a firm rubber having enough flexibility so that they can fit parts that might be slightly different in size; for example, because they were manufactured in a different year. The protection bumpers are designed to slip onto the rigid parts 12, 16a, and 16b, and any other rigid parts in a different design that might cause danger to driver and/or passengers. The protection bumpers must have enough flexibility to slip onto the rigid parts and then remain in place on the rigid parts without slipping off.

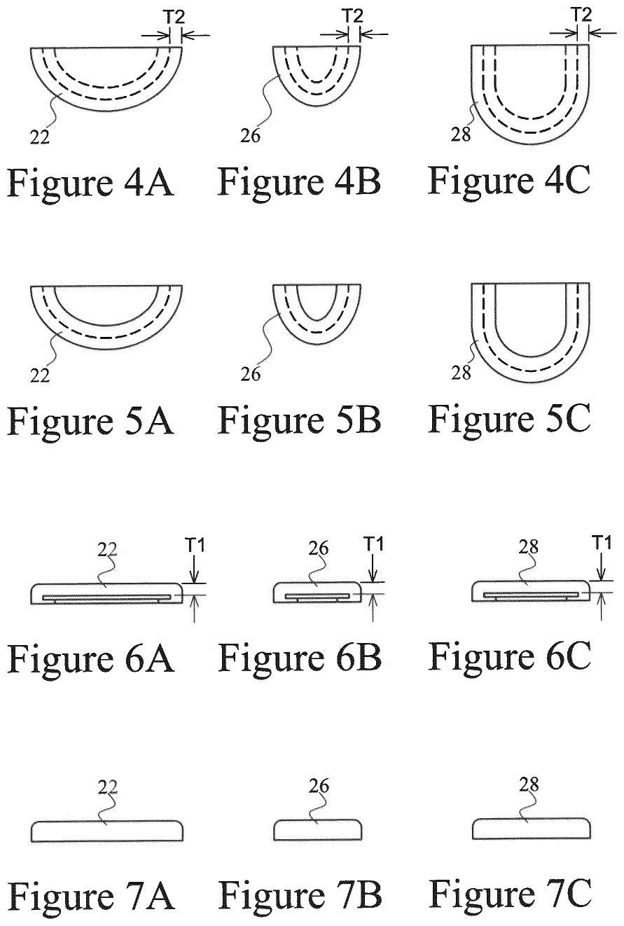

Example protection bumpers are shown in top view in FIGS. 4A-C, in bottom view in FIGS. 5A-C, in back view in FIGS. 6A-C, and in side view in FIGS. 7A-C. FIGS. 4A, 5A, 6A, and 7A show example protection bumper 22 designed to fit onto base plate 12. FIGS. 4B, 5B, 6B, and 7B show example protection bumper 26 designed to fit onto latch apparatus portion 16a. FIGS. 4C, 5C, 6C, and 7C show example protection bumper 28 designed to fit onto latch apparatus portion 16b. The protection bumpers will be designed to a size and shape to fit the rigid parts 12, 16a and 16b that they will cover, being flexible enough to allow for some differences in size of the rigid parts and to fit snugly onto the parts without slipping off inadvertently. Preferably thickness T1 on top of the rigid parts, shown in FIGS. 6A-6C, and thickness T2 in front of the rigid parts, shown in FIGS. 4A-4C, will be at least ¼ of an inch thick.

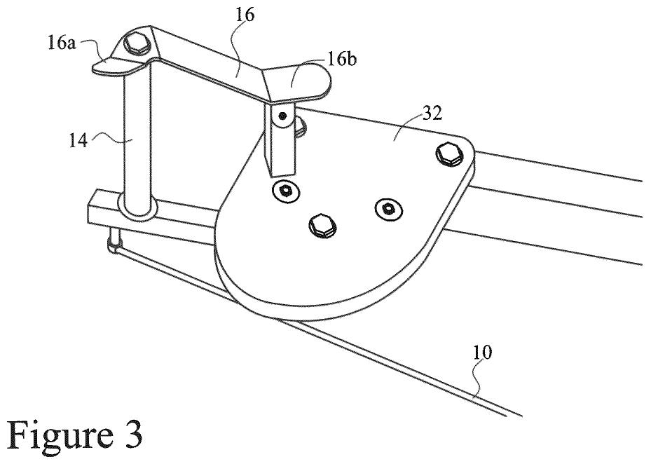

In a second embodiment of the present disclosure, as shown in FIG. 3, the metal base plate 12 of the rotatable pivot arm of FIG. 2 is replaced by a thick, firm rubber base plate 32 having rounded edges. This rubber base plate 32 will cause no or minimal injury to a driver or passenger in case of impact. The rubber base plate 32 of the present disclosure can be replace an existing metal base plate 12 or can be used in future manufacturing of bus door control systems instead of a metal or other rigid base plate. Other dangerous parts such as the two ends 16a and 16b of the latch apparatus could also be replaced with a thick firm rubber part in future manufacturing. Preferably the firm rubber part will have a thickness of at least ¼ of an inch.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter and the appended claims.

What is claimed is:

1. A protection device for a manual bus service door opening mechanism comprising:
at least one first protection bumper configured to cover rigid edges of a rotatable pivot arm, said rigid edges facing an aisle of a bus;
wherein said rotatable pivot arm connects a bus service door to said manual bus service door opening mechanism via a linkage connecting said bus service door to a handle through said rotatable pivot arm.

2. The protection device according to claim 1 wherein said at least one first protection bumper comprises firm rubber having rounded edges.

3. The protection device according to claim 2 wherein said at least one first protection bumper comprises firm rubber having flexibility configured to fit onto said rotatable pivot arm of a range of sizes and snugly enough so as not to slip off inadvertently.

4. The protection device according to claim 2 wherein said at least one first protection bumper has a thickness of at least ¼ of an inch on top of said rotatable pivot arm and a thickness of at least ¼ of an inch covering said rigid edges of said rotatable pivot arm.

5. The protection device according to claim 1 further comprising:
one or more second protection bumpers configured to cover rigid edges of a lock apparatus;
wherein said lock apparatus is positioned adjacent to said handle and is configured to be disengaged prior to operating said service door opening mechanism.

6. The protection device according to claim 5 wherein said one or more second protection bumpers comprise firm rubber having rounded edges.

7. The protection device according to claim 6 wherein said one or more one second protection bumpers have a thickness of at least ¼ of an inch on top of said lock apparatus and a thickness of at least ¼ of an inch covering said rigid edges of said lock apparatus.

8. A protection device for a manual bus service door opening mechanism comprising:
a firm rubber rotatable pivot arm having rounded edges wherein said firm rubber rotatable pivot arm connects a bus service door to said manual bus service door opening mechanism via a linkage connecting said bus service door to a handle through said rotatable pivot arm.

9. The protection device according to claim 8 wherein said firm rubber rotatable pivot arm has a thickness of at least ¼ of an inch.
